(19) United States
(12) Patent Application Publication
(10) Pub. No.: US 2011/0313943 A1
(43) Pub. Date: Dec. 22, 2011

(54) Structured Job Search Engine

(76) Inventors: Brin McCagg, New York, NY (US); Skiddy von Stade, New York, NY (US)

(21) Appl. No.: 13/222,857

(22) Filed: Aug. 31, 2011

Related U.S. Application Data
(62) Division of application No. 12/626,412, filed on Nov. 25, 2009.
(60) Provisional application No. 61/118,335, filed on Nov. 26, 2008.

(51) Int. Cl. G06Q 10/00

(52) U.S. Cl. 705/321

(57) ABSTRACT

Candidates use a computer-based system to create profiles of their job experience, skills, interests, and future job requirements. Companies seeking candidates to fill job positions use the system to create profiles of the positions they seek to fill. The system automatically matches candidates to company searches based on their profiles, and confidentially and anonymously presents the companies with a list of candidates, ranked in decreasing order of the degree of match. The system may also notify candidates of positions which match their profiles. Candidates may earn referral fees from companies by referring positions to other candidates.

### CROSS-REFERENCE TO RELATED APPLICATIONS

This application is a divisional of co-pending and commonly-owned U.S. patent application Ser. No. 12/626,412, filed on Nov. 25, 2009, entitled, “Structured Job Search Engine,” which claims priority from commonly-owned U.S. Prov. Pat. App. Ser. No. 61/118,335, filed on Nov. 26, 2008, entitled, “Structured Job Search Engine,” both of which are hereby incorporated by reference herein.

### BACKGROUND

All organizations are familiar with the high cost of recruiting qualified employees. Furthermore, today's human resources departments have less time than ever to find such employees. Moreover, it is not enough to find employees with impressive credentials if those employees do not closely match the precise needs of the organization. As a result of these and other factors, old-fashioned solutions for matching candidates to organizations in need of employees are ineffective, inefficient, and expensive.

### SUMMARY

Candidates use a computer-based system to create profiles of their job experience, skills, interests, and future job requirements. Companies seeking candidates to fill job positions also use the system to create profiles of the positions they are seeking to fill. The system facilitates creation of both kinds of profiles in a highly structured format, pre-loading permissible profile data into lists for easy selection by users, and guiding users through the profile creation process by soliciting only that information which is relevant. For example, if a user indicates that he is currently employed by a particular company, the system presents areas of specialization for the user to select that are specific to that company. The system automatically matches candidates to company searches based on their profiles, and confidentially and anonymously presents the companies with a list of candidates, ranked in decreasing order of the degree of match. If the company sets up its search as “public,” then candidates will be notified of jobs that have a high degree of fit to their experience, based on the profiles they have built.

A company may indicate to the system that it wishes to communicate with specified candidates. In response, the system notifies the specified candidates (e.g., by email) that the company wishes to communicate with them. The candidates may accept, decline, or refer the request. If a candidate accepts, the system notifies the company of the acceptance and reveals the identity and full profile of the candidates to the company. The company and candidate may then communicate with each other, either through the system or otherwise.

If the candidate declines, the system notifies the company of the declination but strictly maintains the confidentiality of the candidate. If the candidate refers the job to another candidate, the system notifies the other candidate that the job has been referred to him or her. When initiating a search the company has the option to indicate that it will pay a cash bounty for referrals that result in a successful hire. If the company offers such a bounty, the system may facilitate payment of the bounty by the company to the referring candidate.

Other features and advantages of various aspects and embodiments of the present invention will become apparent from the following description and from the claims.

### BRIEF DESCRIPTION OF THE DRAWINGS

FIG. 1A is a dataflow diagram of a system for creating candidate and job profiles according to one embodiment of the present invention;

FIG. 1B is a dataflow diagram of a system for matching candidate profiles with job profiles according to one embodiment of the present invention;

FIG. 2 is a flowchart of a method for matching candidate profiles with job profiles according to one embodiment of the present invention;

FIG. 3 is a timing diagram illustrating communications among an employer, a candidate, and a job matching system implemented according to one embodiment of the present invention; and

FIG. 4 is a timing diagram illustrating communications among an employer, a job matching system, an original candidate, and a referred candidate according to one embodiment of the present invention.

### DETAILED DESCRIPTION

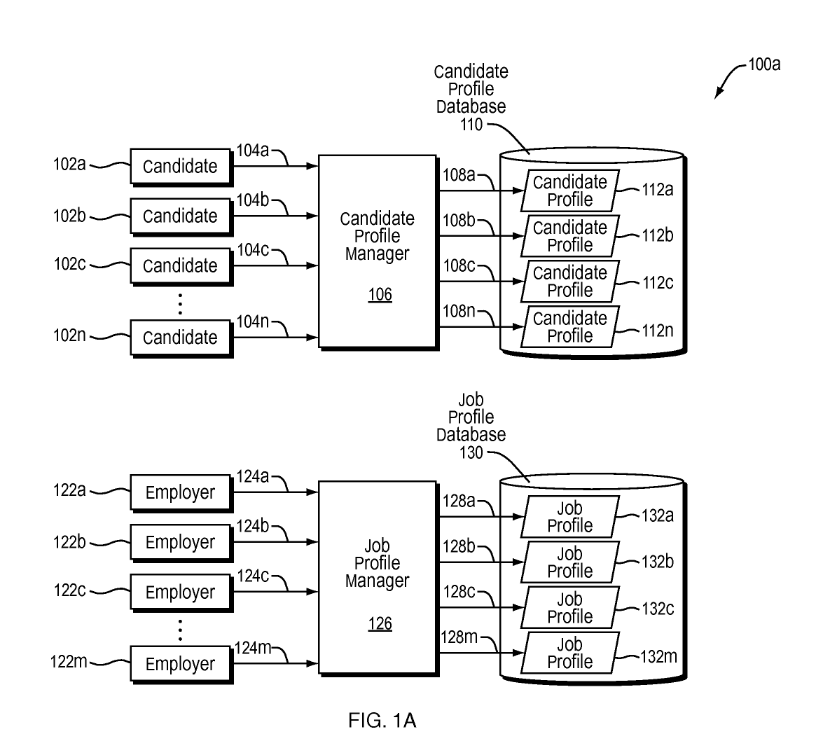

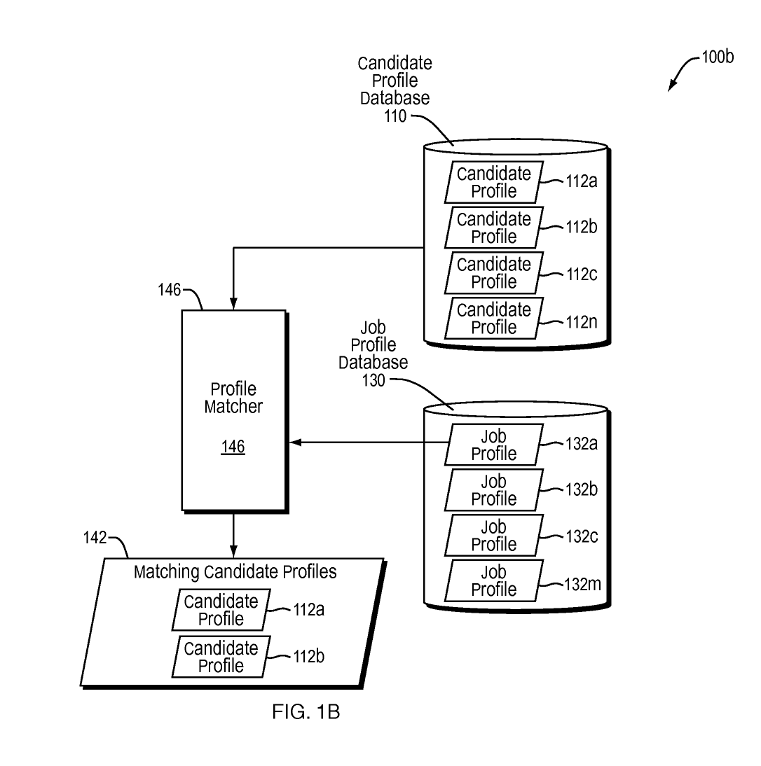

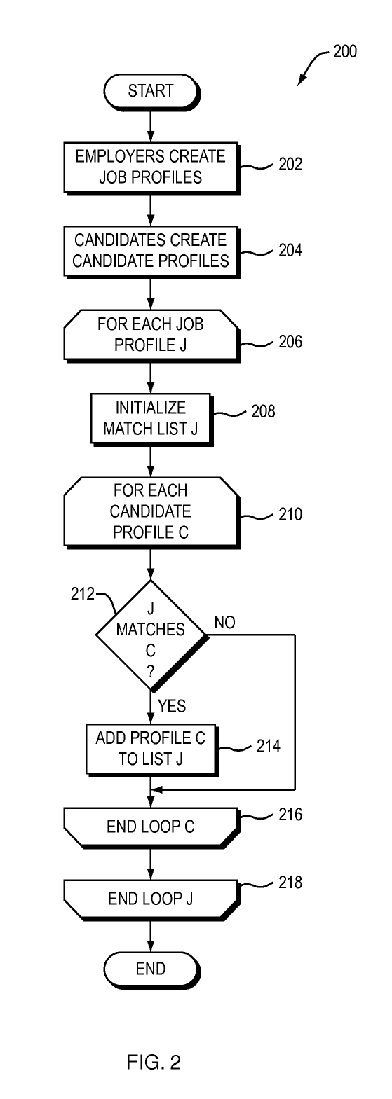

Embodiments of the present invention are directed to systems and methods for matching candidates with organizations in need of employees. For example, referring to FIG. 1A, a dataflow diagram of a job-candidate matching system 100a is shown according to one embodiment of the present invention. Referring to FIG. 2, a flowchart of a method 200 performed by the system 100a of FIG. 1A according to one embodiment of the present invention is shown. These and other embodiments of the present invention may, for example, be implemented as a hosted online system and be accessible to users via the World Wide Web. Although embodiments of the present invention may be implemented using a variety of computing devices, such as desktop or laptop computers, personal digital assistants, or cellular telephones, such hardware is not shown in FIG. 1A for ease of illustration.

A hiring manager, or other person at an organization that is seeking a person to fill a job position, uses the system 100a to create a job profile that describes the position (FIG. 2, step 202). For example, FIG. 1A shows a plurality of employers 122a-m using a job profile manager 126 to create a plurality of corresponding job profiles 132a-m in a job profile database 130. Although four employers 122a-m are shown in FIG. 1A for ease of illustration, more generally any number of employers may use the system 100a. Furthermore, although in the example shown in FIG. 1A, each of the employers 122a-m creates exactly one of the corresponding job profiles 132a-m, this is not a limitation of the present invention. Instead, each of the employers 122a-m may create any number of corresponding job profiles. In general, employers 122a-m create job profiles 132a-m by providing input 124a-m to the job profile manager 126 (such as by entering job profile information using a keyboard and mouse through a web-based graphical user interface), which produces corresponding output 128a-m to create the job profiles 132a-m.

Although elements 122a-m are labeled “employers” in FIG. 1A, and such employers 122a-m may be organizations (such as for-profit or nonprofit corporations, government agencies, or universities), an employer may instead be an individual employer (such as a sole proprietor), or an individual or group within an employer, such as a department or a hiring manager. Therefore any reference herein to an “employer” or “organization” should be understood to refer equally to any other such entity.

Each of the employers 122a-m may have an account on the system 100a for managing positions for which the employer is seeking candidates. The system 100a may include and enforce security policies which allow only the hiring manager and other authorized personnel to create, edit, gain approval for, and delete job profiles for the organization. The system 100a may maintain accounts for multiple organizations, each with its own registered hiring managers or other users, and associated preferences and access rights. A single organization may have multiple accounts. For ease of explanation, however, the following description will refer only to a single hiring manager at a single organization.

The job profile created by the hiring manager for a particular position (such as the job profile 132a created by employer 122a) may include a variety of information about the corresponding job position and the qualifications of candidates sought by the organization, such as the educational background, job role and title, salary, geographic location, and required work experience. The job profile effectively defines a set of search criteria for use by the system 100a to match candidates against the job profile. Further details about information that may be included in the job profile, and ways in which the profile may be used to match organizations with candidates, will be described below.

The system 100a may require and enable the hiring manager to obtain approval of the job profile from a Vice President or other senior member of the organization before the job profile can be finalized and made available for searching.

Candidates 102a-n (also referred to herein as “job seekers”) may also maintain their own accounts on the system 100a. An individual candidate may log in to his or her account and create a personal career profile containing a variety of personal information, including current position, past experience, and future job goals (FIG. 2, step 204). Further details about candidates' profiles will be provided below.

For example, FIG. 1A shows a plurality of candidates 102a-n using a candidate profile manager 106 to create a plurality of corresponding candidate profiles 112a-n in a candidate profile database 110. Although four candidates 102a-n are shown in FIG. 1A for ease of illustration, more generally any number of candidates may use the system 100a. In general, candidates 102a-n create candidate profiles 112a-n by providing input 104a-n to the candidate profile manager 106 (such as by entering candidate profile information using a keyboard and mouse through a web-based graphical user interface), which produces corresponding output 108a-n to create the candidate profiles 112a-n.

Once organizations 122a-m and candidates 102a-n have created their respective profiles 132a-m and 112a-n, organizations' profiles 132a-m may be matched against candidates' profiles 112a-n. In general, any number of job profiles 132a-m may be matched against any number of candidate profiles 112a-n. FIG. 2 shows an example in which all job profiles 132a-m are matched against all candidate profiles 112a-n. More specifically, for each of the job profiles J (step 206) the profile matcher 146 initializes an empty “match list” of candidate profiles for profile J (step 206). For each of the candidate profiles C (step 210), the profile matcher 146 determines whether job profile J matches candidate profile C (step 212). If there is a match (step 212), the profile matcher 146 adds candidate profile C to job profile J's match list (step 214). Steps 212 and 214 repeat for the remaining candidate profiles (step 216), and steps 208-216 repeat for the remaining job profiles (step 218). The result is a match list for each job profile, which contains the candidate profiles (if any) which match that job profile.

FIG. 1B illustrates a simple example of a system 100b in which the profile matcher 146 attempts to match the single job profile 132a against all of the candidate profiles 112a-n in the candidate profile database 110, to produce matching candidate profiles 142. In the example illustrated in FIG. 1B, two candidate profiles 112a and 112c match job profile 132a.

Such matching may be performed in a variety of ways. For example, fields in the job profiles 132a-m may be mapped to fields in candidates' profiles 112a-n that contain the same type of information. For example, the “geographic location” field of an organizations' job profile, which describes the geographic location of the job position, may be mapped to the “desired geographic location” field of a candidate's profile. If both such fields for a particular organization's job position and a particular candidate's profile contain the same information (e.g., “Boston, Mass.”), then the system may consider those fields to match each other.

The job profiles 132a-m may contain fields corresponding to all of the fields made available for use in the candidates' profiles 112a-n. As a result, the system 100 may provide hiring managers with the ability to search for any criteria that candidates may enter in their profiles.

This is merely one simple example of how the job position profiles 132a-m may be matched against candidates' profiles 112a-n. Any of a variety of well-known techniques may be used to perform more complex matching of profiles. For example, data stored in fields of profiles may contain specific values (such as “Boston, Mass.” for a “Job Location” field), sets of values (e.g., “CEO,” “Vice President,” and “COO” for a “Desired Position” field), or definitions of sets of values (e.g., “$50,000-$100,000” for a “Salary” field). Field values of these and other types may be used in a variety of ways to match values in other fields. For example, if a candidate profile indicates that the candidate's desired salary is in the range of $50,000-$100,000, the profile matcher 146 may consider this to be a match for a position offering a specific salary of $75,000 or a position offering a range of salaries from $60,000-$75,000. Any of a variety of well-known techniques may be used for performing such matching.

Fields within a profile may be prioritized in any of a variety of ways. For example, a particular job profile may indicate that the “Years of Experience” field has a higher priority than the “College” field. As another example, a particular job profile may indicate that the value of “Princeton” has a higher priority than a value of “Cornell” as a value of the “College” field. Such prioritization may be performed within job profiles and/or within candidate profiles. Priorities may be implemented in any of a variety of ways, such as sequential rankings (e.g., rankings of fields' importance relative to each other) or weightings. The profile matcher 146 may take such priorities into account to determine whether, and the extent to which, a particular job profile matches a particular candidate profile.

Furthermore, certain information not contained with a profile may be used by the profile matcher 146 as part of the matching process. For example, all job profiles created by a specific organization may be treated as if they contain an “employer name” field containing the name (or other unique identifier) of the organization, for purposes of matching such job profiles against candidate profiles. For example, candidates may specify in their candidate profiles that they are interested in pursuing jobs with specific named employers. When matching candidate profiles against job profiles, the system 100 may match candidate's desired employers against the (implicit) “employer name” field in all job profiles, thereby increasing the likelihood that candidates who are interested in employment with specific employers will be considered a match with jobs posted by those employers. This benefits not only the candidates but the employers, who are likely to obtain more motivated and loyal employees if such employees become employed by employers who they were specifically interested in working for.

The matching process performed by the profile matcher 146 may result in scores representing the degree of matching between any particular pair of job position profile and candidate profile. Scores may be normalized along a standardized scale, such as a scale of 0-100, in which 0 indicates no match and 100 represents a perfect match. Such scores may be stored, for example, within the set of matching candidate profiles 142.

The system 100 may periodically generate such scores for all job profiles 132a-m and candidate profiles 112a-n by using the techniques described above to search for candidate profiles that match each of the job profiles 132a-m in the system 100. As described in more detail below, the system 100 may notify each organization of any matching candidates for each of the organization's posted job positions. Similarly, the system 100 may notify each candidate of any job positions matching the candidate's profile.

Organizations may configure their accounts to specify account preferences, such as the frequency with which such searching is to be performed, the minimum matching threshold (e.g., 50%) that a candidate profile must satisfy to be considered a match (also called a “match floor”), and the maximum number of candidate profiles to be included in the list of matching profiles 142 for a particular job. Candidates may configure their accounts with similar preferences.

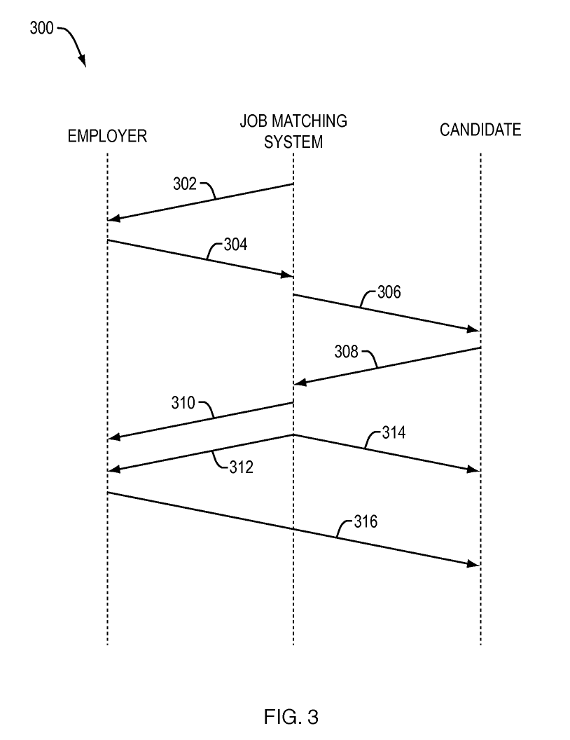

The system 100 may notify organizations and candidates of matches in any of a variety of ways. One embodiment of such a method is illustrated in the timing diagram 300 of FIG. 3, in connection with a single job profile posting by a single organization. In this embodiment, the job matching system 100 first notifies 302 the organization of the candidates (if any) who match the organizations' job profile 132a. For example, as part of this notification the system 100 may provide the organization with the list 142 of candidates whose profiles match the job profile 132a.

The system 100 may withhold certain information about candidates from the organization at this stage, to keep the identities of the matching candidates confidential and/or for other reasons. For example, the system 100 may notify the organization of the candidates' percent match to the job profile 132a, but without revealing confidential information of the candidate, such as his/her name and email address, to maintain the candidate's confidentiality until a later stage in the process. As described in more detail below, for example, the system 100 may only reveal the candidate's confidential information in response to receiving authorization from the candidate to do so. For example, if the candidate has indicated in his or her profile that the profile is “public,” then the system 100 may reveal the candidate's confidential information to the organization immediately (i.e., as part of the search results 142). Otherwise, the system 100 may wait until a later time to reveal the candidate's confidential information to the organization, such as a time at which the candidate has provided a separate express authorization to reveal the confidential information to the organization.

The system 100 may provide the organization with the ability to indicate which, if any, of the matching candidates 142 the organization wishes to contact. The organization's hiring manager may, for example, select a subset of the matching candidates 142 (e.g., the top 10) by checking them off in a list and then hitting a button labeled “Submit” or something similar. This instruction from the hiring manager is transmitted 304 back to the system 100, which retrieves the selected candidates' contact information and then contacts those candidates 306, such as by sending email messages to them notifying them that the organization is interested in communicating with them about an open job position.

The system 100 may provide some or all information about the matching job position to the candidates as part of notification 306. For example, the system 100 may notify the candidates of the job title, required experience, and name of the organization offering the position. The system 100 may, however, keep some information about the job position confidential from the candidates at this stage. For example, the system 100 may withhold the name of the organization from the candidates at this stage.

The system 100 may enable each candidate to accept, decline, or refer any of the job positions sent to him or her. The candidate may, for example, indicate his or her desire by clicking on a button such as “Accept,” “Decline,” or “Refer.” The candidate's choice is then transmitted 308 back to the system 100.

The system 100 notifies 310 the organization of whether the candidate has accepted the organization's invitation to communicate regarding the position. For example, if the candidate accepts the organization's invitation, the system 100 notifies the organization that the candidate has accepted. At this stage, the system 100 may also provide the organization with additional information 312 about the candidate which was previously not provided, such as the candidate's name, telephone number, and email address. Similarly, if the system 100 did not previously provide the candidate with the organization's name, the system may do so 314 at this stage. The system 100 may then either facilitate communication between the organization and the candidate, such as through the use of an online private message board, or simply leave it to the organization to contact the candidate directly, such as by phone or email 316.

If the candidate declines an offer to communicate regarding a position, the system 100 may notify the organization of this declination as part of notification 310. In this case, the candidate's confidential information (e.g., name, telephone number, and email address) may not be revealed to the organization, thereby maintaining the candidate's privacy.

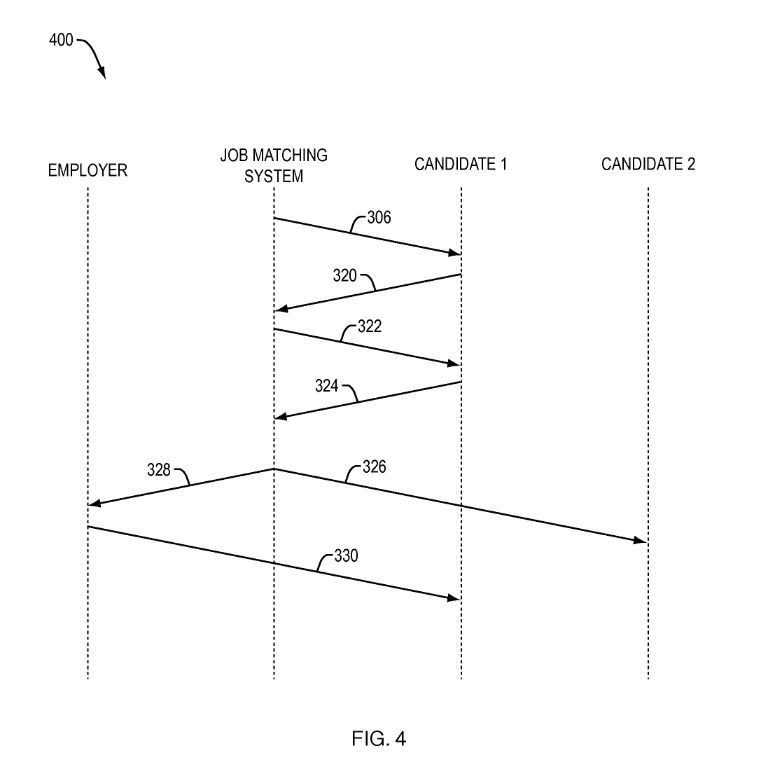

The candidate may choose to refer the position to another candidate instead of, or in addition to, accepting or declining the position, if the candidate knows of another candidate who may be interested in the position. (The system may be configurable to allow the candidate to refer the position only in cases in which the candidate declines the position.) An example of one embodiment of techniques which the system 100 may use to facilitate such a referral is shown in the timing diagram 400 of FIG. 4.

In the embodiment illustrated in FIG. 4, if the initial candidate clicks on “Refer” 320 in response to receiving the invitation 306 to communicate with the employer, the system 100 may prompt 322 the initial candidate to provide information about the other candidate, such as his or her name and email address. This information is transmitted 324 back to the system 100. In response, the system 100 may notify 326 the other candidate that the initial candidate has referred the position to him or her. Alternatively, the initial candidate may make the referral anonymously (i.e., without providing information about the identity of the initial candidate to the other candidate). The system 100 may provide the other (referred) candidate with the same information about the position that was provided to the initial (referring) candidate. The referred candidate may then interact with the system 100 in the same manner as described above with respect to the initial candidate in connected with FIG. 3. In particular, the referred candidate's confidential information may not be provided to the employer unless and until the referred candidate authorizes the system to do so.

If the initial candidate refers a position to another candidate, the system 100 may pay, or facilitate payment of, a referral fee from the organization to the initial candidate for making the referral. The referral fee may be paid as compensation for making the referral itself, regardless of whether the other (referred) candidate contacts the organization or ultimately fills the position. For example, in the embodiment illustrated in FIG. 4, the system 100 notifies 328 the employer of the referral at the same time that the system notifies 326 the referred candidate. In response, the employer pays 330 a referral fee to the referring candidate. Alternatively, for example, the referral fee may be paid to the initial candidate only if the referred candidate is hired by the organization, and possibly if the referred candidate remains in the position for at least some minimum amount of time (e.g., three months).

If the organization and a candidate communicate with each other, the organization may either hire or not hire the candidate. In either case, the system 100 may enable the organization to enter information about the final outcome of the position into the system, such as whether a candidate was successfully found and hired through the system 100. The system 100 may make reports available to the organization for tracking information such as percentage of successful hires, average time from job profile creation to hire, and total number of hires. The candidate may also enter information about the final outcome of the encounter and generate reports about his or her job seeking activity.

Job position profiles 132a-m (created by hiring organizations) and candidate profiles 112a-n (created by candidates) may contain various kinds of information. For example, job position profiles 132a-m may be designed to contain information that is similar to the information that organizations currently provide to traditional search firms. The system 100 may maintain one or more job profile templates, with associated logic, defining the structure and content of information that can be stored in the job profiles 132a-m. Similarly, the system 100 may maintain one or more candidate profile templates, with associated logic, defining the structure and content of information that can be stored in the candidate profiles 112a-m. Different templates may be used for different purposes. For example, one organization may use a job profile template that is customized to suit the needs of that organization. As another example, different candidate templates may be used for candidates in different industries. Such variations may, however, be captured within a single template through the use of appropriate logic.

In general, users may create both job profiles 132a-m and candidate profiles 112-m using a graphical user interface which presents the users with fields in which to enter data into the profile. For example, when a hiring manager creates a new job profile, the system 100 may prompt the user for the title of the profile, and display a text box in which the hiring manager can type a profile title. The system 100 may then prompt the hiring manager to enter the industry of the position, and provide a drop-down list containing a set of industry names from which the hiring manager is required to select.

Once the hiring manager selects an industry, the system 100 may prompt the hiring manager to select a sub-industry. The system 100 may pre-load a list of sub-industries of the industry previously selected by the hiring manager. For example, if the hiring manager selects “Finance” as the industry, the system 100 may pre-load a list of names of sub-industries within the Finance industry, such as Banking, Venture Capital, and Investing. The system 100 may provide this list of sub-industry names within a drop-down list from which the hiring manager is required to select.

This process of pre-loading a list of permissible answers based on the previous answer(s) provided by the user, and requiring the user to select from among the entries in the list, is repeated throughout the process of creating job profiles and candidate profiles. One benefit of this process is that it simplifies the task of entering data into the profile because the user does not need to type the data into the fields. The drop-down lists can also help the user to remember or identity the correct answer to each question. Furthermore, prohibiting the user from entering an answer that does not appear on the drop-down list reduces the likelihood of data entry error, and thereby increases the likelihood that searches subsequently performed on the profile will yield accurate results.

Pre-loaded information may be tailored to individual organizations. For example, if a candidate indicates that he previously worked for IBM, and the candidate is then asked what position he held, the system may pre-load a set of job titles which exist at IBM, and display those job titles in a drop-down list to the candidate. As a result, the candidate can only select a job title that is valid for IBM.

Similarly, if the candidate then selects the job title, “Vice-President,” and the candidate is then asked what responsibilities he had in that job, the system pre-loads a set of responsibilities that are valid for Vice Presidents at IBM. The list of acceptable answers would be different if the candidate had chosen a different job title or a different company. This enables organizations to perform searches that are tailored to their particular structure and requirements, and thereby obtain more accurate search results.

Note, however, that the system 100 may allow users to enter data into profiles in other ways. The system 100 may allow different data entry methods on a field-by-field basis. For example, the system 100 may allow the user to enter data into certain fields by typing plain text. Even in such fields, however, the system 100 may use “quick text” functionality to automatically complete the text that the user is typing, to reduce the amount of text the user must type and to prime the user's memory. The system 100 may also allow the user to enter data into certain fields using slider bars (e.g., to enter numerical values within a certain range), checkboxes, radio buttons, and other graphical user interface elements.

Candidate profiles 112a-n and job profiles 132a-m may include any of a variety of information. For example, in one embodiment of the present invention, candidate profiles 112a-n may include the candidate's:
personal information, such as home phone number, mobile phone number, work phone number, home fax number, work fax number, personal URL, gender, ethnicity, and date of birth;
citizenship information, such as countries of citizenship and visa/working paper information;
military background, such as military branch, highest rank achieved, status (e.g., veteran, active, reserve), country of service, and service start and end dates;
sports and interests, such as affiliations (e.g., non-profit affiliations, board memberships, and association affiliations), non-academic honors, sports, and hobbies;
skills, such as licenses and certifications, languages spoken, computer skills (e.g., software applications and programming languages);
documents, such as the candidate's resume and deal sheet;
educational background, such as schools attended and degrees, fields of study, scholarships, and clubs;
job experience, such as the company worked for, division, title, level (e.g., intern, junior/entry level, middle management, senior management, chief executive level), country, state, city, start and end date, total compensation, and breakdown of compensation into salary, cash bonus, percentage of profit, fees, and dollars at work;
career preferences, such as career status (e.g., actively looking, open to opportunities, or no contact), whether the candidate is open to receiving referrals from other candidates for positions, whether the candidate wishes to donate referral fees to charities, the candidate's desired geographic locations (if any), the candidate's desired salary (if any), the candidate's desired industry sector(s) (if any), the candidate's preferred employer size (if any), the name of the candidate's preferred employer(s) (if any), and the candidate's preference for the employer's amount of assets under management (if any); and
profile visibility, such as whether everyone can search the candidate's profile, whether only specified employers should be able to search the candidate's profile, and whether the candidate's confidential information (e.g., name, address, email address, and telephone number) should be kept hidden or revealed to an employer immediately when the candidate matches one of the employer's searches.

As the description above indicates, a candidate's profile may include not only information about the candidate's past job experience and current skills, but also information about the candidate's requirements in the future, such as whether the candidate is seeking a job in a geographic location that differs from where she lives now, or is seeking to work for a different kind of company than she has ever worked for before. One benefit of including this kind of information in the candidate's profile is that it enables the system 100 to match qualified candidates with employers even if the candidates' previous experience does not indicate that the candidate would otherwise be a good match, and it enables the system 100 to exclude candidates whose qualifications match an employer's criteria but who are not currently seeking a job of the type being offered by the employer. In other words, information about the candidate's future requirements can enable searches to be performed more accurately than searches that rely solely on information about the candidate's previous experience and current skills.

The system 100 guides profile data entry in other ways that facilitates creating more useful profiles. For example, when a candidate indicates that he or she held a particular position, the system 100 prompts the candidate to indicate how much he or she focused on different areas in that position. The candidate may indicate a percentage of time spent for each area using a slider bar or other graphical user interface element. For example, the candidate may indicate the he focused 63% on the U.S. and 37% on Mexico. This is an example of a geographic region “area of focus.” Other examples of areas of focus include a service provided, a type of analysis performed, the market capitalization of companies serviced, the type of projects worked on, the job task performed, the industry sector serviced, the geography serviced, or the title equivalent held in a particular position. The candidate's profile may specify zero, one, or more areas of focus, each of which may be assigned by percentage to different particular values. For each area of focus, the system 100 may verify that the sum of all responses does not total more than 100% and prohibit the candidate for proceeding to the next step until the total does not exceed 100%.

The system 100 may process information in profiles in various ways to produce more accurate and useful search results than conventional systems. For example, consider a candidate who indicates in his profile that he worked for 10 years as the Vice-President of a company, but that he only spent 50% of his time in that role (perhaps he acted as Vice-President 50% of the time and Treasurer 50% of the time). In this case, it is not clear whether the system should treat the candidate as having 10 years of experience or 5 years of experience as a Vice-President (10 years×50%) when attempting to match the candidate's profile against a job profile that specifies a minimum number of years of experience as a Vice-President. As a result, the system 100 may allow each employer, when specifying a minimum number of years of required experience, to indicate whether the number of years should be measured by actual years spent in a position (regardless of the percentage of time spent in that position) or by “effective” years spent in the position (measured by multiplying the number of years by the percentage of time spent in the position). Based on which of these two options the employer chooses, the system 100 will consider different employees to match the employers' need.

For example, if the employer specifies that it is looking for someone with 10 “actual” years of Vice-Presidential experience, then the person who worked 10 years, 50% of the time, as Vice-President will show up as a match for that employer. If instead the employer specifies that it is looking for someone with 10 “effective” years of Vice-Presidential experience, then the person who worked 10 years, 50% of the time, as Vice-President, will not show up as a match for that employer.

Embodiments of the present invention have a variety of advantages over previous systems for matching candidates with employers seeking employees. For example, embodiments of the present invention enable both organizations and candidates to create rich, detailed profiles containing highly structured information, in contrast to the unstructured plain text information commonly found in resumes and online job listings and candidate profiles. The use of highly-structured profiles enables embodiments of the present invention to match employers with relevant, qualified employees more quickly, accurately, and inexpensively than other systems.

One feature of the profiles used by embodiments of the present invention which enables them to produce more accurate search results is that they contain highly-granular structured data, which means that individual pieces of data (such as job position, responsibilities, and years held) are broken down into small pieces and stored in formats which make them easily processed by a computer. Because each piece of data in a candidate profile is stored in a particular data field that is mapped by the system 100 to a corresponding data field in the job profile, the system 100 can unambiguously compare information about candidates to information about positions needing employees. In essence, breaking down and structuring the data in this way enables the system 100 to understand the meaning of the data and thereby to search it quickly and accurately, particularly in comparison to commonly-used unstructured data, such as candidates resumes stored in word processing documents.

Another feature of job profiles and candidate profiles which enables them to produce highly-accurate search results is that the system 100 restricts the data that users can enter into individual fields. As described above, the system 100 may require users to enter data in particular fields by selecting a choice from a drop-down list, or by sliding a slider bar to select a number falling within a limited range. Limiting data entry in this way increases the likelihood that users will enter accurate data and thereby increases the accuracy of searches performed on that data. Similarly, pre-loading permissible data for one field based on the data entered into a previous field further increases the likelihood that data will be entered accurately and that searches will produce accurate results.

In the examples provided above, candidates are not presented with listings of jobs to which they can apply. Instead, the system 100 automatically compares employers' job profiles to candidates' profiles and only enables a candidate to communicate with an employer if the system 100 considers that candidate to sufficiently match the employer's requirements and if the employer specifically indicates interest in the candidate. As a result, employers who use the system 100 disclosed herein are much less likely to be contacted by unqualified or irrelevant candidates than employers who use systems that give candidates full discretion to apply to posted jobs and that use less accurate search techniques than the system disclosed herein.

Embodiments of the present invention address a variety of problems with existing techniques for matching organizations with candidates. For example, embodiments of the present invention produce a variety of benefits to employers, including lower recruiting expenses, reduced time to recruit candidates, increased accuracy of matched candidates, increased control and visibility, increased efficiency, decreased soft costs, and increased confidentiality. The techniques disclosed herein may be used for positions of all kinds at all levels in all industries.

The techniques disclosed herein connect employers with candidates directly, without going through a recruiter or other middleman. As a result, the recruiting process can be completed by internal staff more quickly and efficiently. At the same time, the techniques disclosed herein provide at least the same degree of confidentiality normally provided by an external recruiter.

Furthermore, the job candidate lists provided to the employer may maintain the candidates' confidentiality but still provide the employer with sufficient information to make an initial evaluation of the candidates' relevance. In particular, the system 100 enables firms to search for and hire relevant candidates who already work for the organization. The system 100 may determine that a particular candidate currently works for a particular organization in any of a variety of ways. For example, if the candidate indicates that a range of employment dates ending with “Present” or without an ending date for a particular employer, the system may conclude that the employer is the candidate's current employer. As another example, the candidate may affirmatively indicate in the candidate's profile that a particular employer is the candidate's current employer by clicking on a box labeled “This is my current employer” or something similar. As a result, the system 100 may easily identify the current employer of any candidate.

This feature may be particularly useful for assisting organizations to hire internally (i.e., from within the organization), because the system 100 may notify the hiring manager at the organization of those candidates who match a particular job profile and who currently work at the hiring manager's organization, but without revealing the names of those candidates. If the hiring manager prefers to hire internally rather than externally, the hiring manager may begin by contacting the internal employees through the system, still without revealing the candidates' identities to the hiring manager. The candidates' identities are only revealed to the hiring manager if and when the candidates accept the hiring manager's invitation.

Other techniques may be used to facilitate internal hiring. For example, if a candidate indicates that he or she is currently employed, the system may prompt the candidate for an email address at the candidate's current employer. Once the candidate provides such an email address, the system 100 may verify that the email address is located at the current employer specified by the candidate (such as by comparing the domain name specified by the candidate against the known domain name of the candidate's specified current employer). Furthermore, the system 100 may send a verification email to the email address provided by the candidate, prompting the candidate to confirm receipt of the verification email, and requiring the candidate to confirm such receipt by sending a confirmation email from the email address provided by the candidate. If the system 100 subsequently receives a confirmation email from the candidate, sent from the correct email address (at the employer's domain), the system 100 may create a record indicating that current employment of the candidate by the candidate's specified current employer has been confirmed.

Such confirmation may be used in a variety of ways. For example, if an organization performs a search and instructs the system only to return profiles of candidates whose current employment with the organization has been confirmed, the system may comply with such a request as a result of having performed the confirmation process described above. As another example, if an organization performs a search for candidates, the system 100 may indicate to the organization which of the matching candidates have been confirmed to be current employees of the organization, whether or not such confirmation status is used as part of the matching process itself.

As another example of a way in which the system 100 may facilitate internal hiring, an organization may specify in a job profile that internal candidates are required or preferred. In other words, “internal candidate” may be a field of a job profile and be treated in any of the ways disclosed herein with respect to other fields. For example, it may be given a weight, thereby indicating how strongly the organization prefers internal candidates for a particular position. Similarly, the organization may specifically exclude internal candidates, either absolutely or by expressing a preference not to hire internal candidates. Such a negative preference may, for example, be implemented by assigning a negative weight to the “internal candidate” field. The term “internal candidate,” as it applies to any particular job profile, may include current employees of the organization, past employees of the organization, or both.

Similarly, an organization may indicate in a job profile that the organization requires or prefers “diversity candidates,” i.e., candidates who are women, members of minority racial or ethnic groups, or whose hiring would otherwise promote diversity within the organization according to the organization's particular criteria for diversity. Candidates may indicate in their own profiles that they are diversity candidates. When matching is performed between a job profile in the job profile database 130 and candidate profiles 112a-n in the candidate profile database 110, candidates may be identified in any of a variety of ways, such as by using the contents of the “diversity candidate” fields of the candidate profiles 112a-n, by using a system-wide definition of “diversity candidate,” or by using a definition of “diversity candidate” specified by the particular job profile being matched. This is just another example of a field which may be used in job profiles and/or candidate profiles to facilitate accurate matching between job positions and candidates.

The techniques disclosed herein can automatically and repeatedly match job profiles against candidate profiles to provide employers with lists of qualified, relevant candidates, rank ordered based on how closely they fit the job profile. This enables employers to effectively and rapidly build and sort a list of relevant candidates from a universal and current database.

The ability of the system 100 to pay referral bounties to candidates who refer other candidates to an employer is particular useful because many jobs are filled not by the initial candidates but by someone referred to the employer by the initial candidates. Using referral fees, therefore, increases the likelihood that the employer will be put in contact with highly relevant candidates. Furthermore, because the system 100 can automate the process of paying referral fees to candidates, the system 100 reduces the burden on the employer of paying such fees. Furthermore, if the employers prefers only to pay a referral fee if the referred candidates is subsequently hired by the employer, the system 100 can enforce such a policy automatically by holding the referral fee and releasing it only if and when the employer informs the system that the referred candidates has been hired.

Embodiments of the present invention produce a variety of benefits for candidates, including increased exposure to relevant opportunities, increased confidentiality, increased control over the search process, increased efficiency, increased rewards and networking from referrals, and decreased time wasted.

Candidates may use embodiments of the system 100 disclosed herein as a career management tool. Once the user creates a candidate profile for himself or herself, the candidate may update the profile over time as his or her experience, skills, and preferences changes. In the response the system 100 automatically changes the kind of job opportunities it brings to the candidate's attention, all without requiring the candidate to search or browse through job listings and without sacrificing confidentiality. Therefore the techniques disclosed herein are much more likely to bring job opportunities to an employee's attention when that employee is not actively seeking a new job than systems which require employees to actively perform a search for open job positions in order to be notified of them.

The techniques disclosed herein also benefit candidates by allowing them to include in their profiles their job preferences, not just their past experience and current skills. For example, if someone is currently working in New York in the entertainment industry but is seeking a job in Los Angeles in the finance industry, that person can specify such preferences in his or her profile. As a result, the system 100 will notify such a candidate of open job positions in Los Angeles in the finance industry for which the candidate is otherwise qualified. Existing systems which perform matching based solely on the contents of candidates' resumes and other past experience would fail to identify such a match, to the detriment not only of the candidate but also employers who could benefit from such a candidate.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The term “candidate” is used broadly herein to refer to any person, whether that person is or desires to become an employee, independent contractor, partner, agent, or kind of party to a relationship with an organization. Similarly, the term “organization” is used broadly herein to refer to any entity, such as a for-profit or non-profit company, government agency, educational institution, unincorporated business association, sole proprietor, headhunters, and other recruiters. Furthermore, an “organization” may be a division, department, or other sub-unit of another entity. Although in certain examples described herein, a “hiring manager” of an organization is described as using embodiments of the present invention, any person or people within an organization may interact with embodiments of the present invention on behalf of an organization.

The job matching methods disclosed herein may be made available to users (e.g., hiring organizations and job candidates) in any of a variety of ways. For example, the techniques disclosed herein may be implemented using a hosted online system which may be used by both organizations and candidates to create profiles, match job profiles against candidate profiles, and facilitate communication between candidates and organizations. Such a system may provide services to a wide variety of organizations. One benefit of this implementation is that each organization and job candidate may begin using the service merely by creating an account and one or more profiles on the system 100, without the need to host 100 the system itself.

One disadvantage of such an implementation, however, from the point of view of a hiring organization, is that all candidates who are interested in working for the organization may not visit the centralized hosted web site of the system 100. For example, candidates who are interested in working for a particular organization may, when seeking a job at the organization, visit the organization's web site to find job opportunities with the organization, rather than visiting the web site of the job-matching system 100. If the organization's web site does not provide an easy way for such candidates to express their interest in working for the organization, then such candidates may fail to be matched with suitable positions for them at the organization, even if the organization has an account and job profiles in the system 100.

To facilitate the process of matching such job candidates with suitable positions at the organization, the system 100 may be implemented to include a mechanism on the web site of the hiring organization which enables candidates who are interested in working for the organization to express such interest by registering with the system 100 directly through the organization's web site, thereby avoiding the need for the candidate to leave the organization's web site and visit a separate web site of the system 100.

Such functionality may be implemented in the organization's web site in any of a variety of ways. For example, it may be implemented by providing a link on the “Career Opportunities” page or other similar page of the organization's web site, which prompts the candidate to “Click here to express your interest in working for Company X.” Clicking on such a link will enable the candidate to create a profile in any of the ways described above. As another example, a form may be provided on the organization's web site, through which the candidate may enter some or all of the information necessary to create a candidate profile (such as the candidate's name, email address, and password), without needing to leave the organization's web site.

Regardless of the particular way in which the candidate is enabled to create a profile through the hiring organization's web site, such a process may automatically indicate in the candidate's profile that the candidate is specifically interested in working for this particular organization (i.e., without the need for the candidate to click on a checkbox or otherwise indicate that the candidate has a preference for working for this organization). Once the candidate's profile is created, it may be matched against job profiles in the system 100 in any of the ways described herein.

The techniques disclosed herein may be used to match profiles other than job profiles and candidate profiles. For example, the techniques disclosed herein may be used to enable alumni of a university, school, or other organization (e.g., corporation) to network with each other. Each alumnus may create a profile about himself or herself which is similar to the candidate profiles 112a-n described herein. Each alumnus may also create a profile, similar to the job profiles 132a-m disclosed herein, describing which alumni he or she is seeking to network with. For example, an alumnus of MIT may create a profile for himself or herself indicating that he or she attended MIT, and also create a “search” profile indicating that he or she is looking to find other MIT alumni. The system 100 may then attempt to match this search profile against alumni profiles in the database 110 using the techniques disclosed herein. Various privacy protections may be provided, such as allowing each person to indicate whether his or her profile should be viewable by other alumni and/or by career services offices.

The techniques disclosed herein may operate in connection with one or more communications networks, such as LANs or WANs (such as the Internet), regardless of the protocols and hardware used by such networks. For example, candidates 102a-n may communicate with the candidate profile manager 106 over a network, and employers 122a-m may communicate with job profile manager 126 over a network. Any of the techniques disclosed herein may be performed local or over a network in any combination.

The techniques described above may be implemented, for example, in hardware, software tangibly stored on a computer-readable medium, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) transmitting to a first candidate an indication of an employer's interest in communicating with the first candidate about a job;
(B) receiving from the first candidate a referral message specifying a second candidate; and
(C) in response to receiving the referral message, facilitating a referral payment from the employer to the first candidate.

2. The method of claim 1, wherein (B) comprises:
(B)(1) receiving a response from the first candidate indicating the first candidate is not interested in communicating with the employer about the job;
(B)(2) in response to receiving the response from the first candidate, transmitting to the first candidate a message soliciting the referral message from the first candidate; and
(B)(3) receiving the referral message from the first candidate.

3. The method of claim 1, further comprising:
(D) in response to receiving the referral message from the first candidate, transmitting a job notification message to the second candidate;
(E) receiving from the second candidate a referral acceptance message indicating that the second candidate is interested in communicating with the employer; and
(F) in response to receiving the referral acceptance message from the second candidate, transmitting to the employer information which personally identifies the second candidate.

4. The method of claim 3, wherein (C) comprises facilitating the referral payment in response to receiving the referral message and the referral acceptance message.

5. The method of claim 1, wherein (C) comprises:
(C)(1) receiving the referral payment from the employer; and
(C)(2) providing the referral payment to the first candidate.

6. A computer program product, comprising computer program instructions tangibly stored on a computer-readable medium and executable by a computer processor to perform a method comprising:
(A) transmitting to a first candidate an indication of an employer's interest in communicating with the first candidate about a job;
(B) receiving from the first candidate a referral message specifying a second candidate; and
(C) in response to receiving the referral message, facilitating a referral payment from the employer to the first candidate.

7. The computer program product of claim 6, wherein (B) comprises:
(B)(4) receiving a response from the first candidate indicating the first candidate is not interested in communicating with the employer about the job;
(B)(5) in response to receiving the response from the first candidate, transmitting to the first candidate a message soliciting the referral message from the first candidate; and
(B)(6) receiving the referral message from the first candidate.

8. The computer program product of claim 6, wherein the method further comprises:
(D) in response to receiving the referral message from the first candidate, transmitting a job notification message to the second candidate;
(E) receiving from the second candidate a referral acceptance message indicating that the second candidate is interested in communicating with the employer; and
(F) in response to receiving the referral acceptance message from the second candidate, transmitting to the employer information which personally identifies the second candidate.

9. The computer program product of claim 8, wherein (C) comprises facilitating the referral payment in response to receiving the referral message and the referral acceptance message.

10. The computer program product of claim 6, wherein (C) comprises:
(C)(1) receiving the referral payment from the employer; and
(C)(2) providing the referral payment to the first candidate.
